(19) United States
(12) Patent Application Publication
(10) Pub. No.: US 2025/0372063 A1
(43) Pub. Date: Dec. 4, 2025

(54) Ergonomic Classical Guitar Support

(71) Applicant: Daniel Benjamin Adams, Oberlin, OH (US)

(72) Inventor: Daniel Benjamin Adams, Oberlin, OH (US)

(21) Appl. No.: 18/679,400

(22) Filed: May 30, 2024

(51) Int. Cl. G10G 5/00

(52) U.S. Cl. CPC G10G 5/005

(57) ABSTRACT

This ergonomic guitar support device is made up of a horizontal base behind the instrument, configured to rest on both thighs of the player, and two clamps which extend forward, attaching to the lower bout and waist of the guitar. It enables a seated classical guitarist to position the instrument in an ergonomically optimal position. The clamps allow for simple and quick adjustments to be made to the guitar's orientation according to the player's physical characteristics and chair height. The device has a minimal visual profile to an audience, and is easily disassembled and transported. Though conceived as an aid to holding the classical guitar, the device can be adapted for use with instruments of similar body types.

### BACKGROUND OF THE INVENTION

Unlike the endpin for cello and the chin rest for violin, there has never been an apparatus for positioning the guitar that was both ergonomically sound and widely accepted. Since the advent of the six-string guitar in the late 18th century, players have struggled with holding the instrument in a manner that is comfortable, efficient, and secure. Though some continued to stand and use straps as with earlier guitars, increasing technical demands in the repertoire led to more seated playing. However, a sitting posture requires that the left side of the guitar be raised at an angle so that the player is not required to continually lean to place the left hand on a horizontally oriented neck. In his method of 1810, Fernando Sor, a leading performer and composer, suggested using a table 91 as a physical support, as shown in FIG. 1 (drawing by Michel Delaporte in 1830). This was obviously an imperfect solution, as the availability of suitable chairs and tables varied widely. Several decades later, the virtuoso and teacher Dioniso Aguado promoted a device of his own design, the Tripodison 92, which supported the guitar from a base on the floor, as shown in FIG. 2 (lithograph by J. A. Lopez in 1843). For various reasons, neither of these methods of holding the guitar became popular.

The proposals of Sor and Aguado were intended as alternatives to the common practice of placing a small stool under the left foot to elevate the left thigh, upon which the guitar's lower waist can rest snugly. However, using a footstool requires the player to hold their legs at disparate elevations and angles, which causes torsion on the pelvic girdle and weakens postural support of the paravertebral muscles. As a result, players often lean and twist their torsos excessively to the left as illustrated in FIG. 3, a contemporaneous sketch of maestro Andres Segovia performing with a footstool 93 (drawing by Hilda Wiener in 1932). This left- leaning stance can lead to pain and disability, perhaps shortening the careers of some guitarists. Despite newer devices appearing on the market through the decades, none of them endured and the footstool remains the most widespread accessory among classical guitarists, though this may be due more to its simplicity and widespread availability than its attributes.

In the last several decades, many devices to replace or augment the footstool have gained popularity, and it is fair to say that most players have adopted or at least experimented with them. Many websites and method books now discuss and review various devices or even promote specific ones. The variety of these design concepts and other approaches (cushions, straps, multiple devices, holding the guitar on the right thigh alone, etc.) attests not only to the evolving state of the art, but also to the continuing inadequacy of the footstool. Clearly, a definitive method has not been found and additional developments should be expected.

Most of the more recently developed guitar supports function by simply raising the guitar above the left thigh, rather than raising the thigh up to the guitar as a footstool does. Though this approach allows both feet to rest on the floor, these inventions usually have drawbacks in terms of attaching to the instrument, stability, or portability. Some use suction cups to attach to the guitar, as in Navarro, U.S. patent application Ser. No. 11/706,163, which require frequent moisture, can easily slip, and may mar the guitar's finish.

A recent innovation was to place strong magnets inside the guitar, as in Barnett, U.S. Pat. No. 8,901,403, which attract to corresponding magnets on the external device. However, this limits attachment to a fixed point and any change to the magnets' position requires removing the strings and skilled work inside the body. Other devices use clamping mechanisms made of rigid materials that risk structural damage to the instrument or attach tenuously, as in Olson, U.S. Pat. No. 5,388,492. Some devices, as in Champion, U.S. Pat. No. 9,514,721, fit into the broad curve of guitar's waist and lower bout so that very little horizontal or vertical adjustment is possible. Another recent invention consists of a large plastic plate affixed to the back of the guitar with suction cups, see Gangi, U.S. Pat. No. 10,176,790. However, this device cannot be easily transported in small bags, and adjustment in the horizontal and vertical planes is limited by the constraints of a large cutout for the left thigh once the device is attached.

### BRIEF SUMMARY OF THE INVENTION

This invention is a new device for supporting the classical guitar while playing in a seated position. It may be used for any standard classical guitar or adapted for plucked string instruments shaped and held in a like manner such as a dreadnought-style acoustic guitar, mandolin, ukulele, lute, banjo, or early guitars (Renaissance, Baroque, Romantic, etc.). It may be used for bowed string instruments. It enables the seated user to position the instrument optimally in accordance with ergonomic principles, and eliminates several of the physiological difficulties imposed by previous guitar supports, thus enabling more efficient technique.

The guitar support is made up of a horizontally oriented base wide enough to rest on both of the user's thighs, with non-slip material affixed to the bottom side, and with 2 sets of 3 holes (attachment points), into which forward extending clamps are inserted perpendicularly. The user removes and adjusts the clamps using each clamp's rear-facing knob, which can be removed for disassembly or turned to adjust tension on the instrument. Each clamp consists of a forward and rear member. Because all structural elements are directly attached to or intersect steel hex bolts, the design is inherently sturdy. The device accepts the guitar body in a way supported by gravity and the weight of the right arm, which rests on top of the lower bout and presses the guitar into contoured receiving faces of the clamps.

This device is designed so that adjustments to the guitar's position can be made as quickly and simply as possible according to player physiognomy, chair height, or individual preferences. Neck angle can be changed in seconds by loosening the adjustment knobs behind the base and re-attaching the clamps further right or left on the lower bout. Adjusting the overall height of the guitar is accomplished by removing the adjustment knobs so that the clamps can be inserted into higher or lower holes in the base, which can be done in less than a minute. Horizontal placement is done by simply moving the entire device left or right on the player's thighs, but also more subtly by inserting the clamps in different holes (attachment points) on the base. The angle of the soundboard of the guitar can be altered by moving the device backwards or forwards in relation to the player's torso.

This guitar support comprises a stable platform with extremely low risk of slippage on the guitarist's thighs or detachment from the guitar, so that players will feel comfortable using it with valuable instruments. The use of cork pads at the contact points with the instrument ensures that the wood finish will not be damaged, and that the player can tighten the clamps without risk of damaging the guitar. The contact surfaces with the front of the guitar are shaped to hold the guitar securely while not interfering with vibration of the soundboard, which would limit sound projection. The visual profile from the front of this device is extremely low, comprising only two front-facing clamp surfaces which can easily be made to match the exact color of the guitar itself. All other components, including other parts of the clamps and the base, are either under or behind the guitar.

The most significant change from previous guitar supports devices is that this device includes a contact point with the right thigh. By coupling this contact point with that of the left thigh, the player is no longer required to hold the guitar in place with the right forearm, thus freeing up the right arm and hand to maintain optimal posture for sound production. In addition to the thighs, this configuration only requires one additional contact point on the chest, so that the guitarist is free to move their arms, torso and head more freely. As a result, a guitarist using this device is has significantly more freedom of movement for technical and expressive purposes.

To briefly summarize, this device is designed to address the continuing need for a guitar support that is easy to use, portable, adjustable, sturdy, and guitar-friendly. Its basic mechanism and appearance are unlike any other device produced to date and is therefore non-intuitive. In addition, it represents a fundamental ergonomic improvement in holding the instrument so that the guitarist can move their right arm and upper body more freely.

### DESCRIPTION OF THE DRAWINGS

FIG. 1 is a reproduction of a prior art drawing of a guitar player resting a guitar on a table.

FIG. 2 is a reproduction of a prior art lithograph of a guitar player using a Tripodison guitar support.

FIG. 3 is a reproduction of a prior art drawing of a guitar player using a stool to elevate his left thigh, which in turn supports a guitar.

FIG. 4 is an isometric view from the front of a fully assembled guitar support device, shown with clamps installed in the middle locations, and without a guitar.

FIG. 5 is an isometric view from the back of the guitar support device shown in FIG. 4.

FIG. 6 is a front view of the guitar support device shown in FIGS. 4 and 5.

FIG. 7 is a back view of the guitar support device shown in FIGS. 4-6.

FIG. 8 is a top view of the guitar support device shown in FIGS. 4-7.

FIG. 9 is a bottom view of the guitar support device shown in FIGS. 4-8.

FIG. 10 is an isometric view from the front of a fully assembled guitar support device, with a one-piece base.

FIG. 11 is a left side view of the guitar support device shown in FIGS. 4-9, and also illustrates the plane for the cutaway shown in FIG. 28

FIG. 12 is a right side view of the guitar support device shown in FIGS. 4-9 and 11.

FIG. 13A is an isometric view from the front of a guitar (frame only, with partial neck) being held in the clamps of the guitar support device, with the clamps installed in both middle locations.

FIG. 13B is a front view of a guitar support device with clamps installed in both middle locations, and clamps holding a guitar.

FIG. 14 is a schematic front view of a guitar support device with clamps installed in both bottom locations, and clamps holding a guitar (frame only, with partial neck).

FIG. 15 is a schematic front view of a guitar support device with clamps installed in both top locations, and clamps holding a guitar (frame only, with partial neck).

FIG. 16 is a schematic front view of a guitar support device with the right clamp installed in a top location, and the left clamp installed in a bottom location, and clamps holding a guitar (frame only, with partial neck).

FIG. 17 shows detail views of each of the four main components of the guitar support device: right base member (A), left base member (B), top view of clamp and knob (C), and bottom view of clamp and knob (D).

FIG. 18 is an oblique front view of the two base members unattached, with one member rotated, in preparation for twisting the two base members together.

FIG. 19 is another oblique front view of the two base members unattached.

FIG. 20 is a detail view of the screw joint of FIG. 19, which attaches the two base members together.

FIG. 21 is an exploded oblique view of the screw joint components which are used to attach the two base members to each other.

FIG. 22 is an oblique front view of the right base member, showing the top clamp hole bushing exploded.

FIG. 23 is an oblique close-up view of the right base member with clamp installed.

FIG. 24 is an oblique exploded view of a clamp, with the rear position shown to the left of the Figure, and the front portion to the right.

FIG. 25 is a detail top view of assembly step 1 of 3 of a clamp using the turn-lock.

FIG. 26 is a detail top view of assembly step 2 of 3 of a clamp using the turn-lock.

FIG. 27 is a detail top view of assembly step 3 of 3 of a clamp using the turn-

lock.

FIG. 28 is an oblique cutaway view of a front clamp member.

FIG. 29A is an oblique exploded view of a front clamp member.

FIG. 29B is an oblique view from the front of a rear clamp member.

FIG. 30 is an oblique right side view of the assembled base.

FIG. 31 is an oblique detail right side view of the assembled base shown in

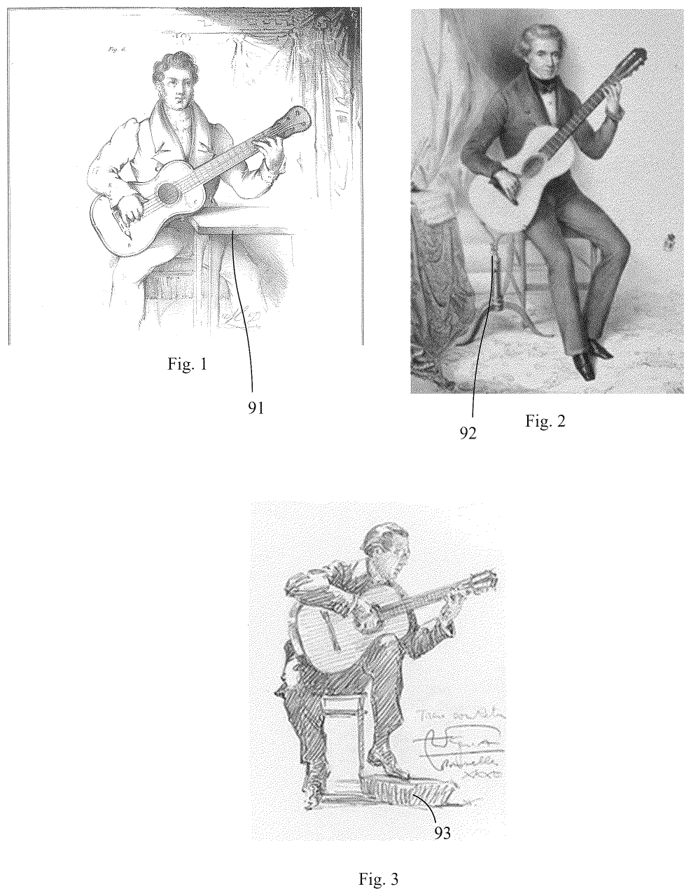

FIG. 30, illustrating the asymmetrical angle of the bottom surface.

FIG. 32 is a front view of an alternate guitar support device with a total of 10 clamp holes.

FIG. 33 is an oblique front view of an alternate guitar support device having a base with extended length on the right side.

FIG. 34 is an oblique front view of an alternate embodiment of the device having a base with a rectangular shape.

FIG. 35 is a front view of the device positioned on a player's thighs, without a guitar attached.

FIG. 36 is a front view of a guitar in the device positioned on a player's thighs, in a normative classical guitar position.

### DETAILED DESCRIPTION OF THE INVENTION

When referring to the several parts of the guitar support device, the frame of reference is that of the guitar player/guitar support device user. For example, the front is the side that faces away from the front of the player when the guitar support device is resting on the guitar player's lap, and the rear is the side that faces towards the player's torso. The right side is the player's right side. The bottom side rests on the player's thighs, and the top side faces generally upwards.

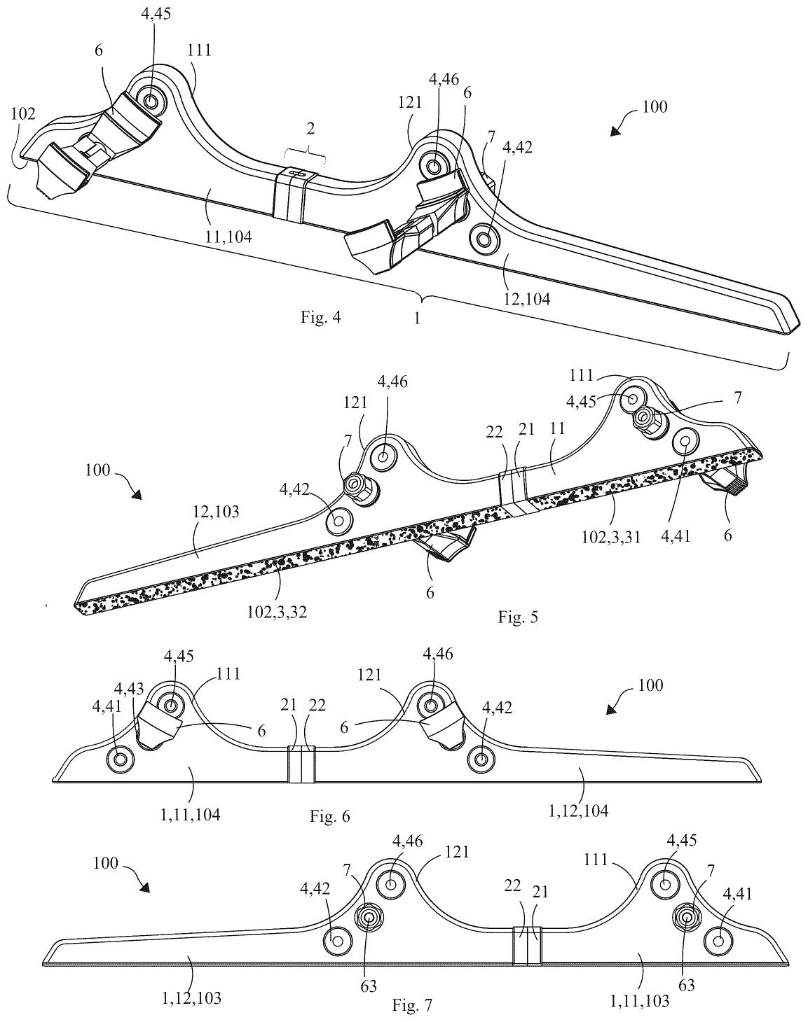

The design of the ergonomic guitar support device 100, shown in FIGS. 4-9, features three main elements: a base 1 which is configured to rest laterally on both thighs behind the guitar, and two clamps 6 which extend forward from the front surface 104 of the base 1 and are configured to attach to the underside of the instrument (see FIGS. 13A-16 and 36). In the preferred embodiment shown, the base 1 is bisected by a screw joint 2 that allows its left 12 and right 11 halves to separate for transport and storage. The base 1 is flat on its inferior side 102 and lined with a non-slip pad 3 (shown in FIG. 5). The two sides of the base 1 feature rounded vertical projections 111, 121 which each house three diagonally or arcuately-configured holes 4 as attachment points.

By inserting the clamp 6 ends into various pairs of holes 41, 42, 43, 44, 45, 46 as shown in FIGS. 4-16, the user can modify the height and horizontal placement of the instrument. The clamps 6 swivel on their long axis 631 (see FIG. 23) so that they can fit onto the guitar 8 (see FIGS. 13A-16) at any point on its side 852, 853. The clamp faces 67, 68 in contact with the guitar 8 are shaped to match the guitar's contour and are lined with cork to provide traction without abrading the finish. Each clamp 6 is tightened or loosened by turning a threaded knob 7 on the back 103 of the base 1, which also serves as a means to separate the clamps 6 from the base 1 for transport and storage.

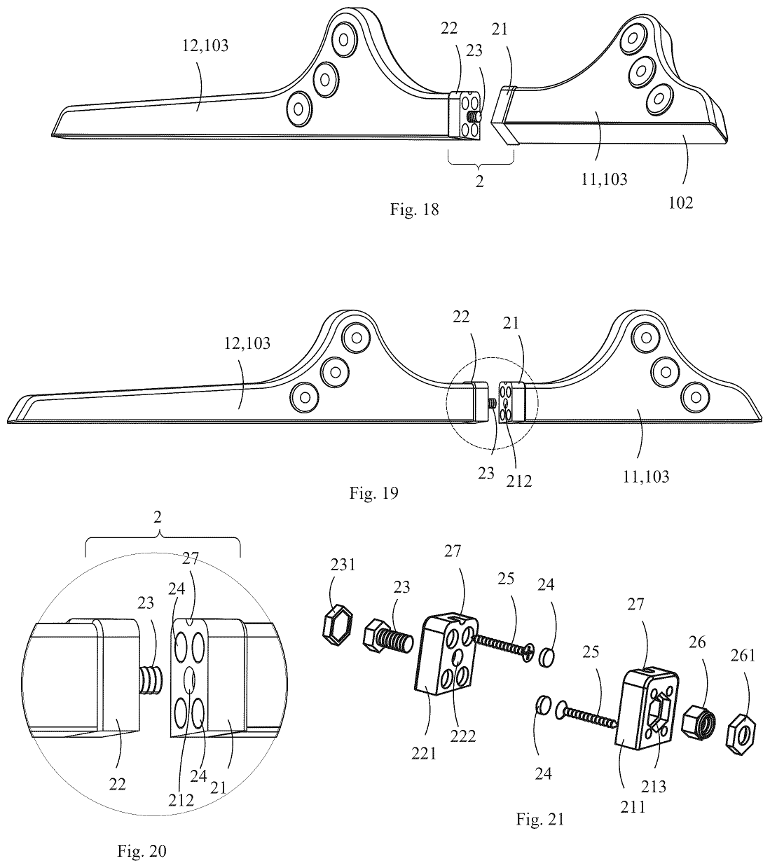

To assemble the device 100, a guitar player screws together the two halves 11, 12 of the base 1, see FIG. 18, and inserts the bolt 63 ends protruding from the proximal clamps 62 of the pre-assembled clamps 6 into the selected holes 4 on the front of the base 1, see FIGS. 22 and 23. The adjustment knobs 7 are then threaded onto the bolt 63 ends where the bolt ends emerge at the back 103 of the base. Attaching the device to the guitar is best done by placing the guitar on one's lap face up with the neck 82 pointing left. With the clamps 6 pointing upward and the base's friction strip 3 facing away, the clamps 6 are swiveled until the cork pads 67, 68 face the lower bout 832 of the guitar. Using the texture ridges 611 as tactile reference points, and the cork pad faces 67, 68 as visual references, the clamps 6 are moved into contact with the guitar top, back, and sides. The adjustment knobs 7 are then tightened to close the clamps 6 onto the guitar 8, and the guitar is then tilted up so that the base's friction strip 3 contacts the player's thighs.

For many players, optimal position of the guitar has its soundboard/top 81 tilted approximately 75 degrees from horizontal, and its neck 82 angled approximately 45 degrees from vertical or horizontal.

FIG. 4 illustrates a preferred embodiment of the assembled device 100, ready for the addition of a guitar. The front and top faces of the left 12 and right 11 base sides are visible, adjoined by the screw joint 2. The left 121 and right 111 verticals extend upward from their respective base sides and house the clamp hole bushings 4. The swivel clamps 6 project forward from the base 1 and, in this view, partially obscure the clamp hole bushings 4.

For FIGS. 4-12, the swivel clamps 6 are shown rotated to the approximate angles for receiving the guitar in a typical position (the left-placed clamp 6 at −30 degrees from horizontal and the right-placed clamp 6 at 30 degrees from horizontal). The swivel clamps 6 are shown in FIGS. 4-12 inserted at the medial holes 43, 44 of each vertical projection 111,121.

The base 1 of the device incorporates features that improve ergonomics, stability, and aesthetics. First, it can be seen that the left base side 12 extends further laterally than the right base side 11. This additional length allows the left base to rest on the player's left thigh when the guitar's body is offset to the right, as in conventional playing. Secondly, the rounded edges and tops of the base and its vertical projections 111,121 minimize potential damage to the guitar in the event of any accidental contact. Finally, in the preferred embodiment, the base 1 is constructed of wood that is stained to match the dark rosewood typical of most guitar bodies in order to minimize its visibility to the audience.

The rear oblique view of FIG. 5 illustrates the rear and bottom faces of the right and left bases 11, 12 and the screw joint 2. The right and left friction pads 31, 32 run the entire bottom surface length of each base side 11, 12. The adjustment knobs 7 are visible where they attach to the swivel clamps 6 protruding from the rear clamp hole bushings 4. Only the distal portions 61 of the swivel clamps 6 are visible in FIG. 5.

The straight flat shape of the inferior base face 102 allows the player to adjust the device laterally while maintaining consistent contact points on both thighs. This is in contrast to the mandolin support of Vrubel, U.S. Pat. No. 1,272,583, which incorporated two concave curves on the bottom side of its base. To increase the range of horizontal adjustment further in the present design, the base in this embodiment is made with additional length to accommodate players of large size and/or wider leg stance. The non-slip pad 3 of the preferred embodiment is made of a textured rubber material to provide traction while not damaging the fine cloth of dress pants, dresses, etc.

FIG. 6 is a front view of the assembled device in the same configuration as the device shown in FIGS. 4 and 5x, and FIG. 7 is a rear view of the same assembled device. In FIG. 7, the ends of the hex bolts 63 are visible through the open end of each adjustment knob 7.

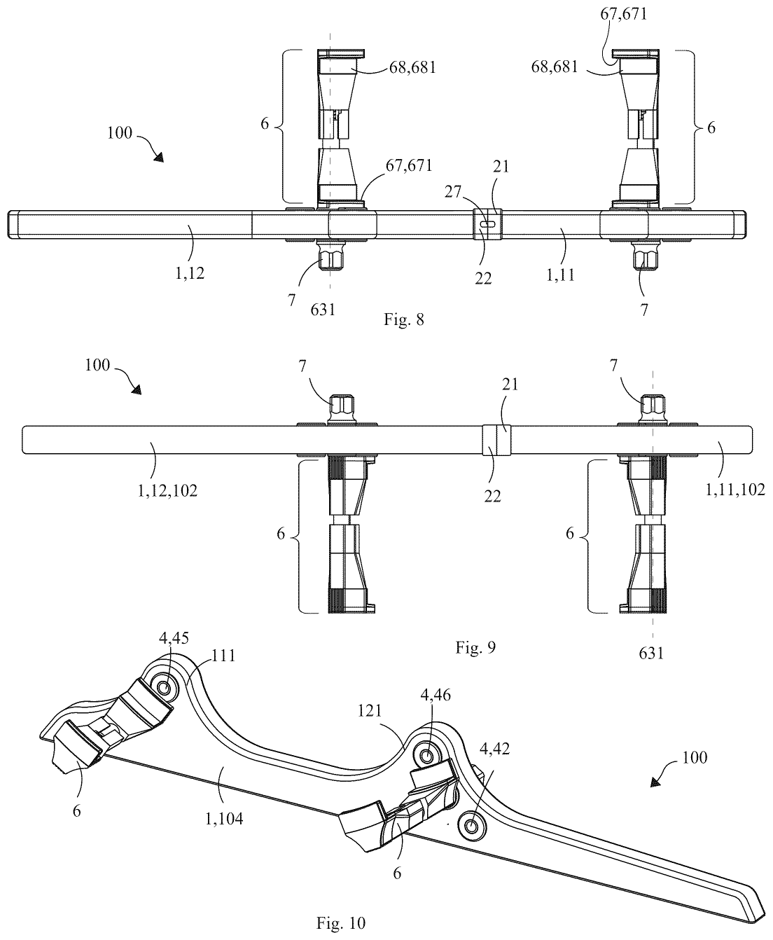

FIG. 8 is a top view of the assembled device in the same configuration as the previous figures, and FIG. 9 is a bottom view of the same assembled device.

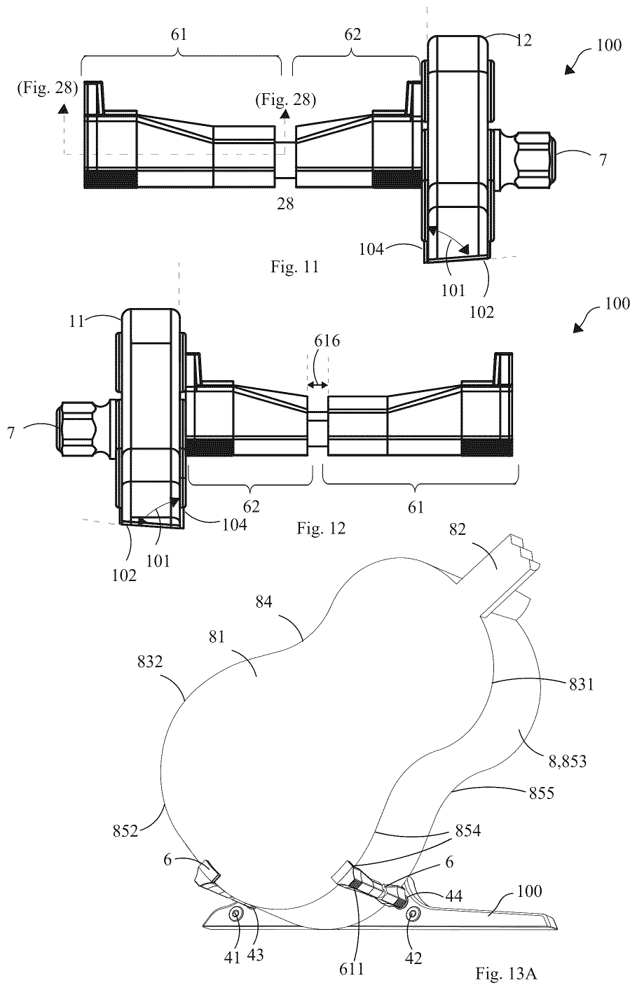

FIG. 10 illustrates an alternate embodiment of the device 100 without the screw joint. This version may be preferable for users more concerned with structural integrity than portability, or for aesthetic reasons.

FIG. 11 is a left view of the assembled device in the same configuration as the previous figures, and FIG. 12 is a right view of the same assembled device. This view illustrates the non-right angle 101 between the plane of the base's back surface and the plane of the base's bottom surface, running the full length of the edge where bottom surface 102 meets front surface 104. The angle 101 can also be seen in FIG. 20. In a preferred embodiment, the angle shown is 75 degrees. The purpose of this angle is to provide an extended flat contact surface with the thighs when the guitar is tilted backwards. This common practice of tilting the plane of the soundboard/top of the guitar backwards from vertical provides better access to the playing surfaces, and projects sound upwards, which is beneficial in high-ceilinged concert halls. To create an embodiment of the device for left-handed players, reversing this angle from front to back would be the only modification necessary, as the other components could all function bi-directionally.

FIGS. 13A, 13B, 14, 15 and 16 are front views of the assembled device illustrating how a guitar's position can be changed depending on which bushings 41, 42, 43, 44, 45, 46 the clamps 6 are inserted into. In FIGS. 13A, 14, 15 and 16, the guitar body 8 is represented in a simple outline as if the neck 82 was oriented at 45 degrees from vertical and horizontal. FIG. 13B shows parts of the guitar in more detail, but without strings. The clamps 6 are rotated so that their insets abut the guitar's side 853 (See FIG. 13A) precisely in each configuration.

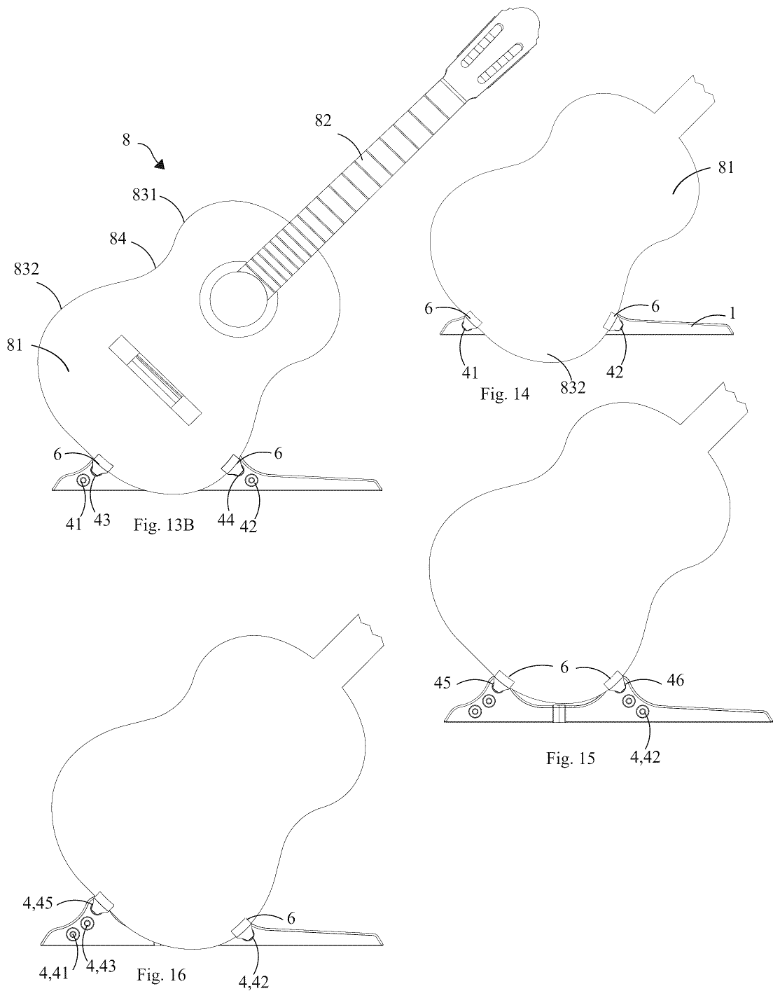

FIG. 14 shows the clamps 6 in the most lateral/lowest bushings/attachment points 41, 42 on both sides of the base 1 so that the guitar 8 is in the lowest position possible. This configuration would be appropriate for a player of relatively short stature, or one sitting in a lower chair.

FIG. 15 shows the clamps 6 in the most medial/highest bushings 45, 46 so that the guitar 8 is in the highest position possible. This configuration would be appropriate for a player of relatively tall stature, or one sitting in a higher chair. Alternative methods for attaching the clamps to the base at attachment points can be imagined, which would be within the scope of this invention. For example, each clamp assembly may be attached to a track on the base front surface, allowing for an infinite number of positions along the path of the track, or allowing the clamps to be set at a finite number of pre-set positions. As another example, each clamp assembly could be hooked onto an attachment point on the base front surface, or attached with a hook draping over the top surface of the base.

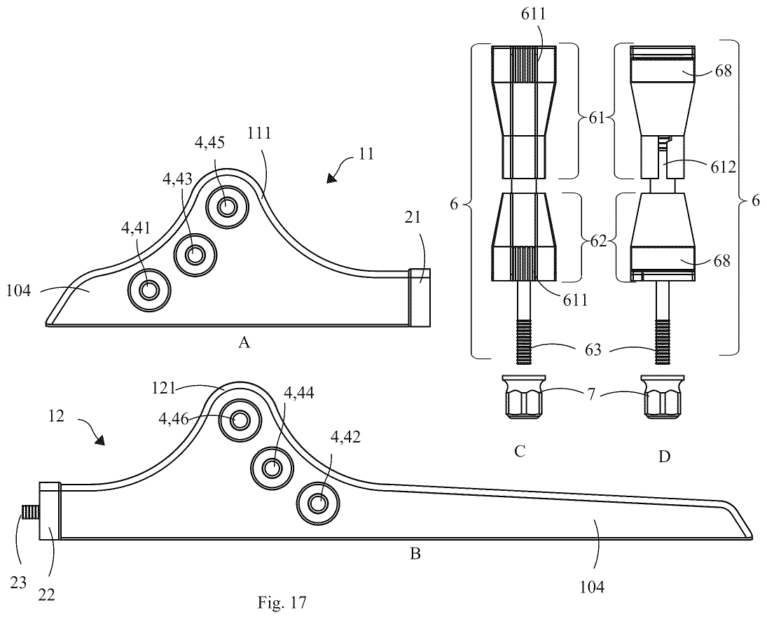

An entirely novel and non-obvious feature of this device is that the diagonal/arcuate arrays of holes 4 in the base vertical projections 111,121 (see FIG. 17) complement the curve of the guitar's lower bout 832, which facilitates a greater range of height adjustment than if the holes were distributed in a vertical line. This is because the height of the guitar 8 is not only determined by the height of the clamps 6, but also inversely proportional to the distance between the two clamps. In FIG. 14, the distance between the clamps 6 is maximized so that the guitar can rest lower, and in FIG. 15, the distance is minimized. The benefit of this arrangement is that the height of the base vertical projections can be minimized, so that the overall shape of the guitar support device remains compact. Higher vertical projections would also increase the risk of contact with the back of the guitar 8 when the lower holes were being used.

The arrangement of the holes 4 also allows for finer gradation in height and horizontal adjustment if used in combination. This is illustrated in FIG. 16, where the guitar rests at a height between those in the previous two figures, and slightly to the right; attachment points/bushings 42 and 45 are utilized. This flexibility is helpful to compensate for variations in chair height, player physiognomy, and preferred angles of holding the instrument. Note that for stringed instruments without bouts, such as a banjo, the device clamps onto the instrument's lower body, and adjustments may be made exactly as described for a lower bout.

An important benefit of having two widely spaced clamps 6 is a broader base of support than devices which attach to the guitar at only one point, or those with two more narrowly placed ones. For example, a device connecting to only the inferior face of the upper bout, as in Barnett, U.S. Pat. No. 8,901,403, could be compromised by the weight of the right arm or by force on the neck as the left hand grasps and releases it. With the design described herein, the weight of the right arm actually reinforces the hold of the stabilizer insets, 671 and 681 (See FIG. 24). As a result, their vertical faces 67 can be relatively small and not dampen the vibration of the soundboard 81.

FIG. 17 shows the device disassembled into its main components for storage or transport. The front faces of both base sides 11(A), 12(B) are visible, whereas the two swivel clamps 6 are shown top (D) and bottom (C). The adjustment knobs 7 are shown oriented to where they would attach to the clamp bolt 63 ends.

Clearly shown on the bottom side clamp C are the ridged pads 611 on the back of the distal 61 and proximal 62 clamp members, which provide the player with a tactile reference when attaching and adjusting the clamps 6. These ridges are placed at the crucial areas where the stabilizer insets 67, 68 make contact with the guitar's soundboard/side angle 854 and back/side angle 855 (See FIG. 13A) so that the user can accurately position the device before tightening the clamps 6.

FIG. 18 shows the right 11 and left 12 base components detached with the right base 11 rotated relative to its long axis, with the open screw joint 2 showing. FIGS. 18 and 19 show the concept of how the two base components 11, 12 are to be screwed together. FIG. 20 is a blown-up view of the circled area in FIG. 19, a close-up oblique view of the open screw joint 2 with the two base sides 11, 12 separated. The left 12 and right 11 base sides are shown from the front and right, aligned to be screwed together for assembly. Visible are the distal end of the joint bolt 23 and the aperture 212 that the bolt 23 inserts into. The four round caps 24 covering the wood screw heads are also shown, being flush with the interior face of the left screw joint side. Alignment notches 27 are visible on the upper surface of each joint side.

Rather than a hinge or other type of joint to connect the base sides 11, 12, the screw joint 2 was chosen for the preferred embodiment to maximize strength along the long axis of the device and simplify disassembly. Because the interior faces of both joint sides sit flush against each other once assembled, there is very little potential for movement in any direction. The placement of the joint between the vertical projections 111, 121 further prohibits stress on the joint when the guitar is attached, as the guitar itself provides stabilization. The alignment notches 27 provide a visual reference during assembly so that the user may quickly align the left 12 and right 11 base sides at full insertion.

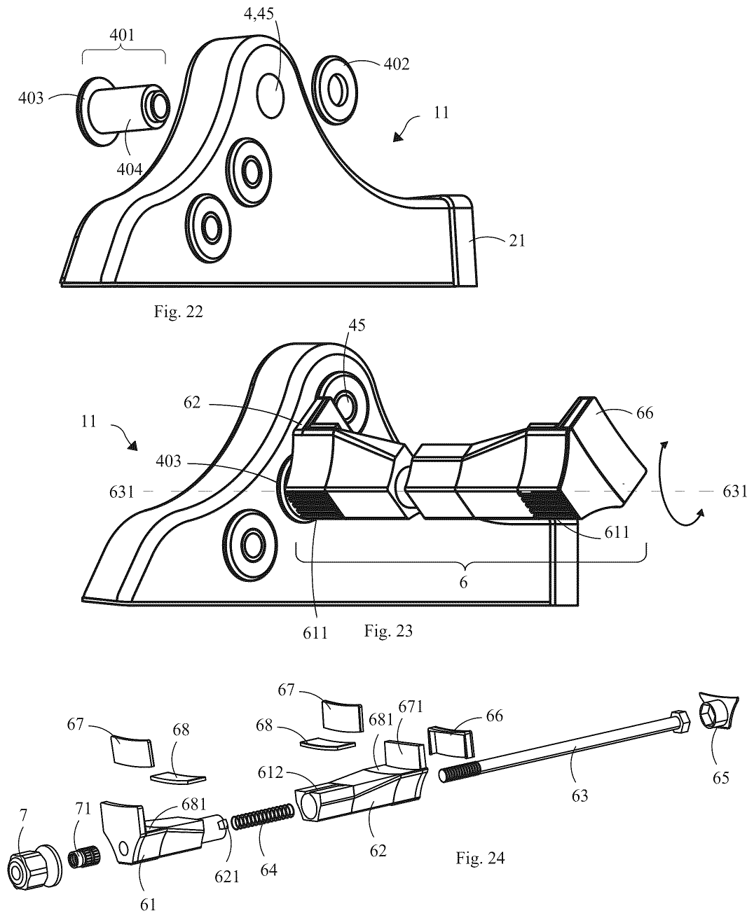

FIG. 21 is a close-up oblique exploded view of the screw joint as seen from the right. From the left side of the illustration, the components of the left screw joint shown are: a bolt cap 231, a bolt 23, a left screw joint body 221, one of four left wood screws 25, and a left wood screw cap 24. Continuing right, the components of the right screw joint shown are: a wood screw cap 24, one of four right wood screws 25, a right screw joint body 211, a locking nut 26, and a locking nut cap 261.

In this view, it can be seen that the locking nut 26 is held in a hex-shaped pocket 213 with its locking nylon collar on the lateral side away from where the bolt is inserted. In this orientation, the locking nut 26 initially allows the bolt to rotate freely but creates resistance from the nylon collar as it nears full insertion. This keeps the bolt from loosening when the base sides 11, 12 are fully attached and prevents vibration between these two metal parts. A corresponding hex pocket (not visible) on the left joint side keeps the head of the bolt 23 in place. Both the nut 26 and bolt 23 are further stabilized by hexagonal caps 231, 261 that fit over their lateral portions. In the preferred embodiment, these are glued to the right and left screw joint bodies 211,221 so that the nut 26 and bolt 23 do not exert direct pressure on the wood, which might loosen the joint over time. The rotational orientation of the bolt can be adjusted during construction so that the joint sides line up exactly at the point of maximal insertion/rotation.

Four screws 25 on each joint side ensure a durable bond between the joint sides and the medial faces of the base sides where they adjoin. End caps 24 covering the screw heads prevent their loosening and provide smooth interior faces on the two joint sides. The features just described all contribute to the stability and durability of this crucial joint, which must withstand heavy use. Alternative mechanisms for attaching the right and left base portions can be imagined, which would be within the scope of this invention. Alternatively, the base may be made of one piece instead of two, as shown in FIGS. 10 and 34.

FIG. 22 is an exploded view of the upper clamp hole bushing 45 in relation to the right base 11 as seen from the right side. The middle 43 and lower 41 bushings are unexploded in this view. Each bushing 41, 43, 45 is composed of a plug 401 and an end cap 402. The plug 401 inserts into its base hole 4 posteriorly and extends slightly beyond the anterior face. A widened portion, the collar 403, abuts the back surface of the base and a narrowed portion, the neck 404, inserts into the end cap 402 anteriorly. Alternative attachment points and mechanisms other than through-holes can be imagined, which would be within the scope of this invention.

The clamp hole bushings allow the clamp assembly bolts 63 to slide smoothly through the base holes 4 during assembly and adjustment. The end cap 402 provides a flush contact point anteriorly so that the rear clamp member 62 can rotate against it evenly. The collar 403 serves the same purpose for the adjustment knob 7 posteriorly.

FIG. 23 is an oblique front view of the right swivel clamp 6 attached to the base 11 and rotated to 45 degrees. Though only a partial arc of rotation (approximately 30 degrees) is required in conventional positioning, the swivel clamps 6 are capable of rotating 360 degrees. This would be a problem if they were allowed to swing loosely on their axes, as the user would have to hold them at the required angle while simultaneously manipulating the adjustment knobs 7 and orienting the device to the guitar. However, this is prevented by pressure from the compression spring 64 (shown in FIG. 24), which keeps the rear clamp member 62 and the clamp hole bushing 402 in stable contact. Therefore, there is no need to limit the full arc rotation of the clamp 6 with stops or additional design elements. The compression spring 64 also keeps the two swivel clamp members apart on either side of the guitar until brought together by the action of the adjustment knob, thus adjusting the clamp span. This enables the user to focus on positioning and tightening without having to hold the swivel clamp members 61, 62 apart.

FIG. 24 is an exploded view of a swivel clamp assembly seen obliquely from behind and above. Starting on the left side of the illustration, the components of the assembly are: an adjustment knob 7, a threaded insert for the adjustment knob 71, a rear clamp member body 61, the vertical cork pad 67 of the rear inset, the horizontal cork pad 68 of the rear inset, a compression spring 64, a front clamp member body 62, the horizontal cork pad 68 of the front inset, the vertical cork pad 67 of the front inset, a color plate 66, a clamp bolt 63, and a bolt head cover 65.

The right and left clamp assemblies are interchangeable, which simplifies assembly. Their maximum span between the opposing interior faces of the insets (in the preferred embodiment, 15 mm) is sufficient to compensate for any variation in the depth of standard size classical guitars or the slight decrease in depth as the guitar body usually tapers slightly approaching the neck. Alternative span adjustment mechanisms can be imagined which would be within the scope of this invention.

The clamp bolt 63 serves as a strengthening element for the design as a whole, as it runs through both clamp members 61, 62 and the base 1. In the preferred embodiment, the bolt's shaft is tightly fitted into the front clamp member 61 through a hole in its long axis 631 and the hex bolt head is securely fitted into the hex-shaped pocket in the hex head cover 65. The hole of the rear clamp member 62 fits more loosely around the clamp bolt 63 so that the member can freely slide along the non-threaded portion of the bolt shaft during adjustment, thereby changing the clamp members' overall span. The fit of the clamp bolt 63 through the hole bushings 4 of the base 1 is tighter than the bolt's fit into the rear clamp, allowing only slight lateral movement as the bolt 63 moves through this opening during adjustment and assembly.

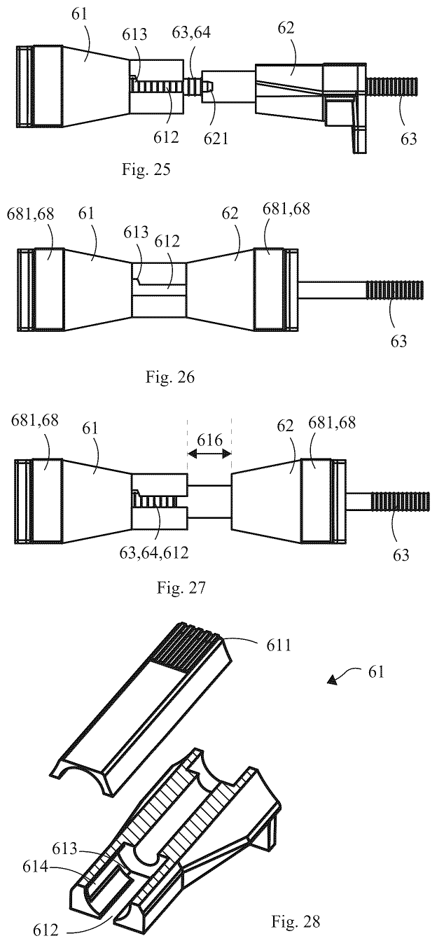

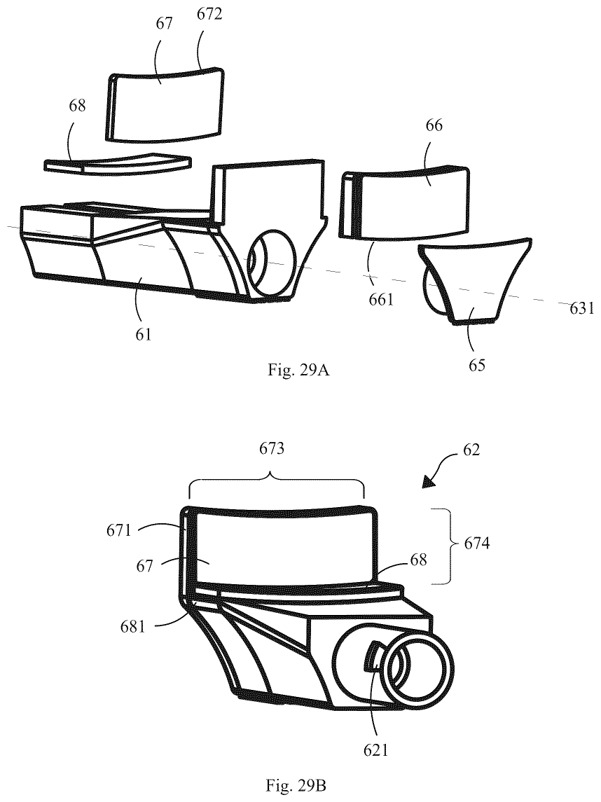

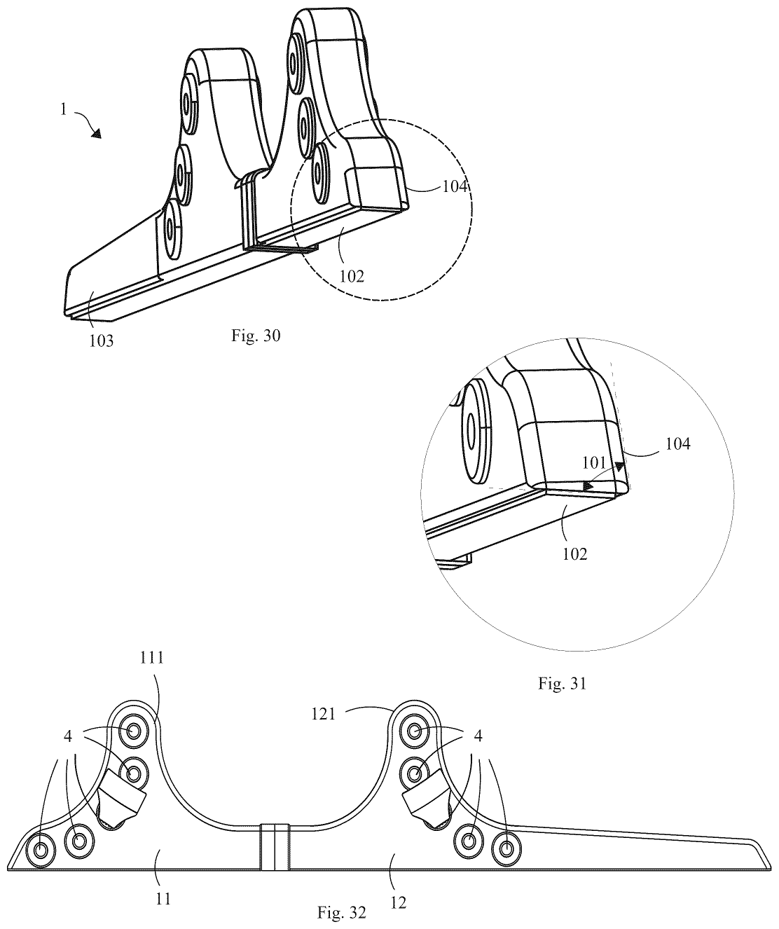

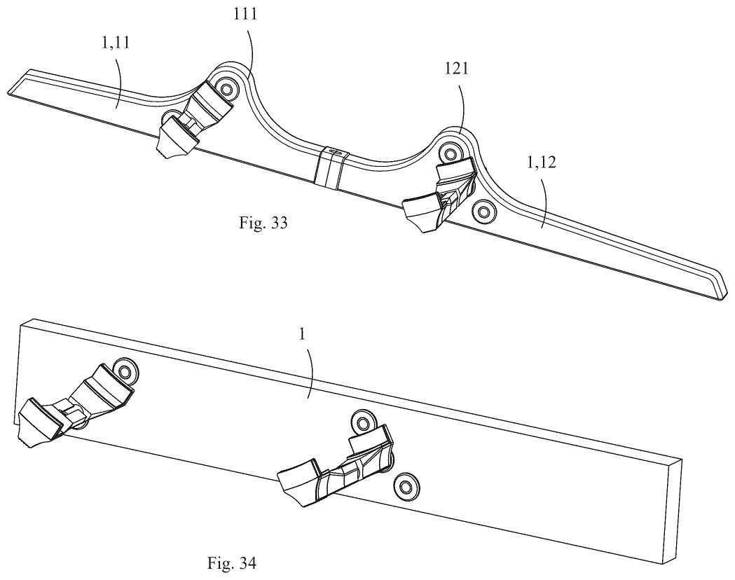

FIGS. 25-28 illustrate the action of the turn-lock of the assembled clamp 6 in its three phases of assembly. FIG. 25 shows the front 61 and rear 62 clamp members aligned so that the externally placed slide block 621 at the distal end of the rear member 62 can move into the external groove 612 of the front clamp member 61. The compression spring 64 is at full extension in this view. Note that at this step, the rear clamp member is turned approximately 90 degrees from its eventual in-use position as shown in FIGS. 26 and 27, allowing the slide block 621 to be aligned with the external groove 612.

FIG. 26 shows the rear clamp member 62 fully inserted and twisted approximately 90 degrees from its position in FIG. 25, so that the slide block 621 can and does turn into the horizontal groove 613 of the front clamp member 61. FIG. 28 shows that the horizontal groove 613 follows an arcuate path within the distal segment of the front clamp member 61, connecting the external groove 612 with the blind internal groove 614. The compression spring 64 is now fully compressed and not visible in this view because it is inside a blind hole on the distal end of the rear clamp member 62. FIG. 27 shows the rear clamp member 62 rotated so that the two clamp members 61, 62 are aligned. The slide block 621 is no longer visible and is aligned with the blind internal groove 614 so that the rear clamp member 62 can slide away from the front member 61 as the compression spring 64 expands.

FIG. 28 is a cutaway view of the front member 61, shown upside-down as compared with FIGS. 25-27, and cut away to reveal the blind internal groove 614 where the slide block 621 catches and holds. See FIG. 11 indicating the plane of the cutaway.

When the turn-lock is fully assembled, the rear clamp member 62 slides along the hex bolt 63 relative to the front clamp member 61 so that the vertical faces of each clamp's stabilizer insert 671 can be 92 mm to 107 mm apart. This 15 mm span 616 allows the clamp to loosen and tighten around the average depth of a standard classical guitar body (approximately 100 mm) while allowing for reasonable variability between instruments. In other possible embodiments, the clamp span could be modified in order to accommodate non-standard guitars or similar instruments with different body depths.

After assembly, the swivel clamp members 61, 62 are aligned and the rear clamp member 62 cannot detach from the front member 61 without reversing the process described above. This simplifies assembly and adjustment because the user does not have to align each clamp member 61, 62 individually. Also, the turn-lock mechanism prevents the rear clamp member 62 and compression spring 64 from sliding off of the clamp bolt 63. This aids storage and transport by reducing the number of separated components from ten to four (when the adjustment knobs 7 are attached to the clamp bolts 63).

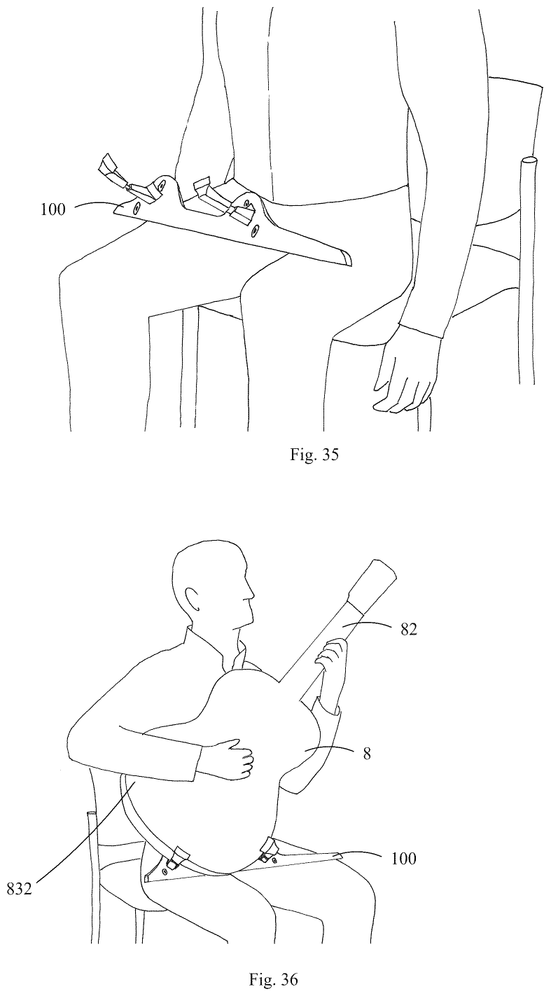

FIG. 29A is a view of a front swivel clamp body 61 as seen from the front with the color plate 66 and hex plug plate 65 exploded. The cork pads 67, 68 are also shown exploded from the stabilizer insets.

This view illustrates the sectional composition of the distal face of the front swivel clamp 61, which is the part of the device most visible to an audience. All other parts of this device are either under or behind the instrument and are thus less visible to an observer in front of the player. To reduce the visual profile of the front swivel clamp in the current embodiment, its distal face is divided into an upper section consisting of the color plate 66 and a lower section, the backing plate 65 of the hex bolt 63. The color plate 66 can be made to match the color of any guitar's soundboard (light yellow spruce or orange cedar are the most common). The color plate's convex lower border 661 follows the contour of the soundboard's edge so that it is camouflaged to blend in with the guitar. The lower section, the backing plate 65 of the hex bolt 63, is black in the preferred embodiment to match the darker underside of the guitar and its shadow.

FIG. 29B is a view of the rear swivel clamp body 62 as seen from the front. The vertical 671 and horizontal 681 faces of the stabilizer insert are visible with their cork pads 67, 68. The slide block 621 is seen on the distal end of the body as well as the hole that accepts the proximal portion of the compression spring 64 and keeps the spring in place between the two clamp members 61, 62.

Unlike some other designs which hold the guitar by clamping rigidly onto the opposing planes of the soundboard and back, the contact surfaces of the present device hold the guitar securely but gently without risking damage to the guitar, marring its finish or dampening the vibration of the soundboard. Both clamp members 61, 62 contact the guitar at stabilizer insets consisting of two faces 671, 681 oriented approximately perpendicular to each other. The horizontal faces 681 abut the guitar on its side and their concave shape complements the contour of the guitar's body. The vertical inset faces 671 abut the guitar on its soundboard (front clamp member 61) and back (rear clamp member 62). The vertical faces 671 are at a slightly obtuse angle (92 degrees in a preferred embodiment) with the horizontal faces 681, to match typical soundboard-side 854 and back-side 855 corners/edges (as shown in Figure13A).

The concave upper edge 672, large width 673 and small depth 674 of the vertical stabilizer insets 671 result in an even application of pressure on the perimeter of the soundboard. This is an optimal area for clamping because the joint between the side and soundboard is reinforced with many corner braces and the side, being a single piece of wood, is resistant to compression. This is also where the soundboard vibrates least, so contact here has a minimal effect on loudness or timbre. In the preferred embodiment, thin cork pads 67, 68 line the stabilizer inset faces 671, 681. Cork was chosen for the preferred embodiment because it provides enough traction to hold the clamp 6 in place, but does not damage the guitar finish through chemical reaction.

The design of the preferred embodiment incorporates several features intended to increase the loudness of the unamplified guitar, which has always been a quiet instrument compared to the piano, voice, and orchestral instruments. As noted above, the placement and shape of the stabilizer insets 671, 681 minimize interference the soundboard's vibration. In addition, the solid wood and steel components, as well as densely printed PLA filament, conduct sound vibrations with no noticeable decay. Finally, the design removes the guitar's inferior waist and lower bout from direct contact with the player's thighs, which also dampen vibration. The net effect of these features is to increase loudness in comparison to footstool use.

FIGS. 30 and 31 illustrate a preferred embodiment of the angled base, wherein the angle 101 between the plane of the base's front surface 104 and the plane of the base's bottom surface 102 is 75 degrees. Alternative embodiments could have angles between 60 and 90 degrees, or a more rounded inferior/back edge (where back surface 103 meets bottom surface 102) to accommodate player preference or comfort.

FIG. 32 shows an alternate embodiment of the guitar support device, with elongated vertical projections 111,121 to accommodate two additional clamp holes 4 on each base side 11,12. FIG. 33 shows an alternate embodiment of the guitar support device, with a longer right base 12 for players who prefer holding the guitar more medially. FIG. 34 shows an alternate simplified embodiment of the guitar support device, with an unshaped block base 1, but having clamp holes 6 in the same configuration as in the shapelier preferred embodiment. This simplified shape would be heavier and bulkier than the preferred embodiment

FIG. 35 shows the device positioned in a typical orientation on the player's thighs without a guitar attached. FIG. 36 shows a guitarist holding the guitar support device with guitar attached. The normative classical guitar position is shown, with the instrument's body offset to the guitarist's right, the soundboard tilted back approximately 15 degrees from the vertical, and the neck angled approximately 45 degrees.

The view in FIG. 35 best illustrates how the base resting on both thighs facilitates an ergonomic improvement unique to this guitar support. In conventional classical guitar positioning, the guitar has four areas of contact: the left and right thighs, the chest, and the right forearm. This arrangement is inherently unstable because the right forearm must maintain contact with the superior curve of the lower bout 832 or the guitar will slide forward and off of the right thigh. Though the left hand can temporarily hold the instrument when the right arm is lifted, this constant need to stabilize it with the arms creates two problems: 1) the relatively fixed stance of the right arm restricts movement of the torso, and 2) the right arm may not be able to align the fingers with the strings in accordance with the demands of muscle function and tone production. These limitations can lead to postural inefficiency, muscle rigidity, and hinder technical progress-especially when ingrained over time. The device herein described resolves these issues by coupling the right thigh contact point with the left one along the horizontal base 1, so that the lower bout 832 is much less likely to slide off of the right thigh and the right arm is freed from having to hold the guitar. The instrument rests on a stable base inferiorly and against the chest posteriorly, so that both arms are free in their full range of motion. This, in turn, creates more freedom for the torso, neck, and head to avoid rigid postures. All of this allows guitarists to enjoy unprecedented technical and expressive possibilities similar to those enjoyed by pianists and cellists.

The assembly process of the preferred embodiment of the device for a user is herein described: Assemble the wood base 1 by inserting the right side bolt 23 (and right base member 11) into the right aperture 212 and screwing it into the nut 26 on the left base member 12 until both sides of the base 1 are secured tightly and aligned precisely using the alignment notches 27. (See FIGS. 18-21.)

Attach the two clamp assemblies 6 to the base 1 by inserting the threaded end of each bolt 63 into the holes 4 on the front side 104 of the base 1 until the threaded ends of the bolts 63 protrude approximately 1 cm out of the back 103 of the base 1. (See FIGS. 17A-17D.) It is recommended that the middle holes of each side be used when setting up the device for the first time. Partially screw the adjustment knobs 7 onto the threaded bolt ends where they emerge behind the base 1 until the rear clamp members 62 contact the end caps 42. The device is now fully assembled.

The guitar attachment process is herein described: With the guitar 8 positioned face up on a surface such as the guitarist's lap so that the neck 82 is pointing left, hold the device so that the front clamp 61 ends are pointing upwards and the base friction surface 3 is facing away from the guitarist. Position the device with the base under the guitar and the colored segments 66 of the clamp visible at the lower bout 832 and waist 84.

Swivel the clamps 6 so that the cork pads 67, 68 face the guitar 8 and bring the device alongside the guitar so that the body fits into the cork pads 67, 68. After using the texture ridges 611 on the opposite sides of the clamps 6 to push the device into the pads 67, 68, and watching for full contact of the stabilizer insets 671, 681, gently tighten the adjustment knobs 7 until the clamps 6 can no longer be easily pushed off the guitar.

The guitar position adjustment is herein described. Bring the guitar 8 into playing position with the base 1 resting across both thighs as in FIG. 35.

Two positional changes can be made in playing position: The angle of the top can be adjusted by simply moving the device slightly forward towards the knees (to decrease the angle of the top with respect to the floor) or backward towards the body (more perpendicular to the floor). The lateral position of the guitar can be changed by simply sliding the device right or left on the thighs.

The following adjustments should only be done with the guitar back on the lap or other stable surface as before: If the neck 82 angle is too high, loosen the clamps 6 and shift the guitar support device along the body of the guitar towards the left. If too low, move the guitar support device towards the right while holding the guitar in place. If the guitar sits too high, re-insert the clamps 6 into one or more of the lower set of holes 41, 42 on the base 1. If the guitar is sitting too low, re-insert the clamp members 6 into one or more of the higher holes 45, 46.

The disassembly process for a user is herein described: Place the guitar 8 face up on one's lap with the neck 82 pointing left. Loosen the adjustment knobs 7 and remove the device 100 from the guitar 8. Fully unscrew the adjustment knobs 7, slide the clamps 6 out of the base, and unscrew the base sides 11, 12. For transport and storage, the user can reattach the adjustment knobs 7 to the clamp bolts 63 to reduce the number of separate parts.

All components of the preferred embodiment described below are 3D-printed carbon fiber-infused PLA filament except for the steel fasteners (bolts 63, wood screws 25, compression spring 64, etc.) or otherwise specified (wood base 1, rubber friction strip 3, cork pads 67 68). Conceivably, the 3D-printed parts could be made in a variety of filament types and colors, or mass produced with injection molding. Likewise, the base 1 could be manufactured as a molded part or crafted with different wood species.

1. A support device for use with a guitar or other stringed instrument during music playing, the support device comprising:
a base support member with a bottom surface, front and back surfaces, a top surface, an axis, right and left portions, and a conceptual midline located between the right and left portions;
a plurality of attachment points located on the front surface of the right portion (right set of attachment points);
a plurality of attachment points located on the front surface of the left portion (left set of attachment points);
two or more clamp assemblies configured to receive a stringed instrument, and having front and rear members;
wherein each clamp assembly is attached to an attachment point; and
wherein each right base portion and left base portion has a medial end nearest to the base's conceptual midline, and a lateral end farthest from the base's conceptual midline.

2. The support device of claim 1, wherein the base bottom surface further comprises a layer of anti-slip material.

3. The support device of claim 1, wherein said left base portion is longer than said right base portion.

4. The support device of claim 1, wherein said bottom surface has a plane which is tilted, having an acute angle between the bottom surface plane and the front surface, and having an obtuse angle between the bottom surface plane and the back surface.

5. The support device of claim 1, wherein, in each set of attachment points:
the most lateral attachment point of the set is located closest to the base's bottom surface;
the most medial attachment point of the set is located closest to the base's top surface; and
any additional attachment points of the set are located vertically and horizontally in between the most lateral and most medial attachment points of the set.

6. The support device of claim 5, wherein each set of attachment points is configured in an arc.

7. The support device of claim 1, further comprising:
a curved vertical projection extending upward from the top surface of each of the right and left base support portions; and
wherein one or more of the plurality of attachment points in the right and left portions is at least partially located on a vertical projection.

8. The support device of claim 1, wherein the right and left base portions are detachable from each other.

9. The support device of claim 8, further comprising:
wherein the medial ends of the right and left base portions are configured to be removably attached to each other with a screw joint mechanism; and
wherein each medial end has a guide notch on its top surface, each guide notch being configured to align with the other guide notch when both base portions are aligned in proper position for use of the support device.

10. The support device of claim 1, wherein:
each said clamp assembly swivels around an axis which is perpendicular to the base support member axis;
the front swivel clamp member houses a clamp bolt head, so that the front swivel clamp member and clamp bolt head move together; and
the rear swivel clamp member has a central axial through-hole which receives a clamp bolt shaft, and said clamp member through-hole is configured to allow the rear swivel clamp member to slide axially along the bolt shaft.

11. The support device of claim 1, wherein the clamp assemblies further comprise:
vertical and horizontal receiving faces on the front clamp member; and
vertical and horizontal receiving faces on the rear clamp member.

12. The support device of claim 11, wherein the receiving faces of each clamp assembly further comprise a layer of cork.

13. The support device of claim 11, wherein:
the front vertical and horizontal receiving faces form obtuse angles configured to precisely receive front and side contours of a stringed instrument; and
the rear vertical and horizontal receiving faces form obtuse angles configured to precisely receive back and side contours of a stringed instrument.

14. The support device of claim 11, wherein:
the clamp assemblies extend in front of the front base surface, and are configured to receive a guitar's lower bout and waist;
the front vertical receiving faces are configured to receive a guitar's soundboard;
the front and rear horizontal receiving faces are configured to receive a guitar's side; and
the rear vertical receiving faces are configured to receive a guitar's back surface.

15. The support device of claim 1, wherein each clamp assembly further comprises a front face, said front face having a color to match a guitar's soundboard, and having a bottom edge with a contour to match a guitar's soundboard contour.

16. The support device of claim 10, wherein each clamp assembly further comprises a slide-lock mechanism comprising:
a female slide-lock portion within the front member, comprising an exterior channel which runs parallel to and is configured to receive the clamp bolt shaft, an interior groove which runs perpendicular to the clamp bolt shaft, and a blind interior groove which runs parallel to the clamp bolt shaft;
a male slide-lock portion within the rear member, comprising a block protruding from an outer surface of a distal end of the rear member in a direction perpendicular to the clamp bolt shaft, the block being configured to fit into the female slide-lock portion's exterior channel, interior groove, and blind interior groove for the purpose of aligning and attaching the swivel clamp members; and
a compression spring mounted on the clamp bolt shaft between the front and rear clamp members.

17. The support device of claim 16, further comprising;
wherein each attachment point is a through-hole from the front base surface to the back base surface;
wherein each clamp bolt shaft is inserted into a through-hole from the front base surface to the back base surface, and an adjustment knob is installed onto said bolt shaft;
wherein said adjustment knob is configured to adjust the length of the clamp bolt shaft which protrudes from the front base surface; and
wherein the compression spring is configured to push the front clamp member away from the base front surface, thus holding the clamp assembly in an infinite number of positions between fully compressed and fully extended positions, as adjusted using the adjustment knob.

18. A clamp assembly, comprising:
front and rear members, aligned and mounted along a shaft of a clamp bolt;
a female slide-lock portion within the front member, comprising an exterior channel which runs parallel to and is configured to receive the clamp bolt shaft, an interior groove which runs perpendicular to the clamp bolt shaft, and a blind interior groove which runs parallel to the clamp bolt shaft;
a male slide-lock portion within the rear member, comprising a block protruding from an outer surface of a distal end of the rear member in a direction perpendicular to the clamp bolt shaft, the block being configured to fit into the female slide-lock portion's exterior channel, interior groove, and blind interior groove for the purpose of aligning and attaching the swivel clamp members; and
a compression spring mounted on the clamp bolt shaft in between the front and rear clamp members.

19. A method of assembling the support device of claim 9, comprising the steps of:
joining the medial ends of the left and right base portions together;
using a twisting motion to screw the left and right base portions together, until the medial ends touch one another, and the guide notches are aligned;
choosing first and second clamp assemblies with front and rear members which are mounted on first and second clamp bolts, and each configured to swivel around a shaft of said clamp bolt;
choosing a base with attachment points that comprise through-holes which pass between front and back surfaces;
inserting a first said clamp bolt shaft into an attachment point on the right base portion front surface, such that the first clamp assembly remains in front of the base, and a distal end of the first clamp bolt shaft extends out beyond the back base surface;
installing a first attachment knob on the distal end of the first clamp bolt shaft;
inserting a second said clamp bolt shaft into an attachment point on the left base portion front surface, such that the first clamp assembly remains in front of the base, and a distal end of the second clamp bolt shaft extends out beyond the back base surface; and
installing a second attachment knob on the distal end of the second clamp bolt shaft.

20. A method of mounting and adjusting a guitar or other stringed instrument in the support device of claim 1, comprising the steps of:
choosing a guitar or other stringed instrument with a neck, a front surface, a side, a lower body and a back surface;
choosing clamp assemblies with a span adjustment mechanism;
placing said instrument with the front surface facing upwards and the side of its lower body facing front;
placing the assembled support device in front of the instrument, with base bottom surface facing front, clamp assemblies extending upwards and positioned to receive the lower body of the instrument;
moving said support device towards the instrument, so that said each said clamp assembly contacts a portion of the instrument's lower body's side, front surface and back surface;
tightening the span adjustment mechanism of each clamp assembly;
tilting the instrument into a playing position, with the instrument front surface facing front; and
placing the instrument and support device on a seated musician's lap, so that the base bottom surface contacts the musician's thighs;
evaluating whether the instrument is positioned to the musician's preference;
if a different lateral position is preferred, then moving the instrument and support device left or right on the musician's thighs;
if a different angle of the instrument's front surface in relation to vertical is preferred, then moving the instrument and support device forward or backward on the musician's thighs;
if a different angle of the instrument's neck in relation to horizontal is preferred, then tilting the guitar backwards to a stable position, and loosening clamp span adjustment mechanisms, moving the support device left or right in relation to the instrument's lower body, and re-tightening clamp span adjustment mechanisms;
if the instrument is too high, then tilting the guitar backwards to a stable position, and loosening one or more of the clamp span adjustment mechanisms, moving the one or more clamps to a more lateral attachment point, and re-tightening the clamp span adjustment mechanisms; and
if the instrument is too low, then tilting the guitar backwards to a stable position, and loosening one or more of the clamp span adjustment mechanisms, moving the one or more clamps to a more medial attachment point, and re-tightening the clamp span adjustment mechanisms.
